(19) United States
(12) Patent Application Publication
(10) Pub. No.: US 2023/0123518 A1
(43) Pub. Date: Apr. 20, 2023

(54) MOTION-BASED GENERATION OF APPLICATIONS IN VIRTUAL REALITY AND AUGMENTED REALITY SYSTEMS

(71) Applicant: META PLATFORMS, INC., Menlo Park, CA (US)

(72) Inventor: Priyanka Sharma, Cupertino, CA (US)

(73) Assignee: META PLATFORMS, INC., Menlo Park, CA (US)

(21) Appl. No.: 17/501,521

(22) Filed: Oct. 14, 2021

(51) Int. Cl. G06F 3/01; G06Q 30/06

(52) U.S. Cl. CPC G06F 3/017; G06F 3/011; G06Q 30/0601

(57) ABSTRACT

A head-mounted display device includes a motion capturing device and a display coupled to the motion capturing device. Based upon the motion capturing device ascertaining a sports-based motion carried out by a user, a computer processor in the head-mounted display identifies the sports-based motion and generates sports-based applications on the display that are specific to the sports-based motion identified using the motion capturing device. The computer processor identifies the sports-based motion by comparing the sports-based motion to a repository of sports-based motions of the user of the head-mounted display.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Head-mounted display devices (also called herein head-mounted displays) are gaining popularity as a means for providing visual information to a user. Head-mounted displays typically have limited mechanisms for allowing users of the head-mounted displays to access applications, which is problematic, especially when the user is immersed in the virtual reality realm provided by the head-mounted displays. Having limited access to applications during use of the head-mounted displays prevents users of the head-mounted displays from enjoying the optical experiences that can be provided by the head-mounted displays while using virtual reality and augmented reality systems.

### BRIEF DESCRIPTION OF THE DRAWINGS

FIG. 1 is a diagram illustrating an artificial reality system in accordance with some embodiments;

FIGS. 2 is a schematic diagram illustrating a head-mounted display device of FIG. 1 in accordance with some embodiments;

FIG. 3 is a block diagram illustrating an architecture of the head-mounted display device of FIG. 2 in accordance with some embodiments;

FIG. 4 is an illustration of various sports-based motions in accordance with embodiments; and

FIG. 5 is flowchart diagram illustrating a method of generating sports-based applications in accordance with embodiments.

### DETAILED DESCRIPTION

As used herein, “artificial reality” may refer to a form of electronic-based reality that has been manipulated in some manner before presentation to a user, including, for example, virtual reality (VR), augmented reality (AR), mixed reality (MR), hybrid reality, simulated reality, immersive reality, holography, or any combination thereof. For example, “artificial reality” content may include completely computer-generated content or partially computer-generated content combined with captured content (e.g., real-world images). In some embodiments, the “artificial reality” content may also include video, audio, haptic feedback, or some combination thereof, any of which may be presented in a single channel or in multiple channels (such as stereo video that produces a three-dimensional (3D) effect to the viewer). Further, as used herein, it should be appreciated that “artificial reality” may be associated with applications, products, accessories, services, or a combination thereof, that, for example, may be utilized to create content in artificial reality and/or utilized in (e.g., perform activities) in artificial reality. Thus, “artificial reality” content may be implemented on various platforms, including a head-mounted display device (HMD) connected to a host computer system, a standalone HMD, a mobile device or computing system, or any other hardware platform capable of providing artificial reality content to one or more viewers.

As used herein, a “destination” may refer to any user defined or developer defined artificial reality location, environment, entity, object, position, user action, domain, vector space, dimension, geometry, coordinates, array, animation, applet, image, text, blob, file, page, widget, occurrence, event, instance, state, or other abstraction that may be defined within an artificial reality application to represent a reference point or a join-up point by which users of the artificial reality application may readily identify and directly navigate (e.g., instantaneously or near-instantaneously) thereto. For example, in some embodiments, a “destination” may correspond to a predefined virtual location, a virtual place, a virtual community, a virtual lobby, a virtual microcosm, a virtual macrocosm, a video gaming level, a video gaming competition (e.g., match), a video gaming mode (e.g., single-player mode, multiplayer mode), a particular longitudinal and latitudinal intersection (e.g., specific coordinates), or other particular position or point in space suitable for user join-ups within a particular artificial reality application.

As used herein, a “deep link” may refer to any link address, pathname, or other locating mechanism that may be utilized or launched to “teleport” (e.g., virtually transport instantaneously or near-instantaneously) artificial reality users to one or more specific destinations within an artificial reality application. For example, in some embodiments, a “deep link” may correspond to a Uniform Resource Locator (URL) or a Universal Resource Indicator (URI) that may be launched within an artificial reality application or outside of the artificial reality application to transport other users to, or allow the other uses to, navigate to one or more specific destinations within an artificial reality application. In one embodiment, a “deep link” may be a link (e.g., website link, hyperlink, URL, URI) that may be launchable or selectable on a first electronic device incapable of executing an artificial reality application, and the destination or application to which the link is directed may be then instantiated on a second electronic device capable of executing the artificial reality application.

As used herein, HMD may refer to a device which includes wearable projected displays, usually stereoscopic in the sense that each eye may be presented with a different field of view so as to create the 3D perception. An HMD may be, for example, a wrap-around visual interface to display computer output. In some embodiments, the computer display information is presented as a three-dimensional representation of real-world environments. As used herein, the term ‘artificial reality navigation’ may refer to moving throughout the artificial environment which results in a respective change of the scene projected onto the eyes of the user.

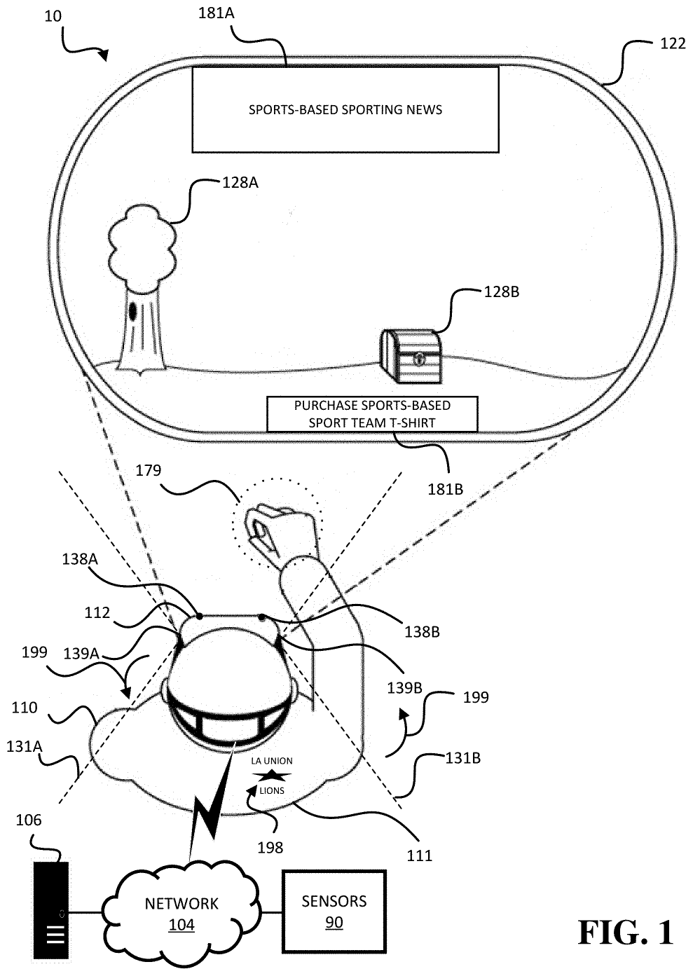

FIG. 1 illustrates an example artificial reality system 10 in accordance with some embodiments. In some embodiments, a head-mounted display device 112 (HMD 112) in artificial reality system 10 is configured to utilize a sports-based application generator to generate a sports-based application 181 (or sports-based applications 181) in the HMD 112 for view and navigation by user 110 within an artificial reality environment. In some embodiments, artificial reality system 10 includes HMD 112, console 106, network 104, and, in some examples, one or more external sensors 90. In some embodiments, HMD 112 may be worn on the head of user 110 and includes an electronic display and optical assembly for presenting artificial reality content 122 to user 110. In addition, HMD 112 includes one or more sensors (e.g., accelerometers) for tracking motion of the HMD 112 and may include one or more image capture devices 138 (image capture device 138A and image capture devices 138B), and image capture devices 139 (image capture device 139A and image capture devices 139B). In some embodiments, image capture devices 138 and image capture devices 139 may be, for example, cameras, line scanners and the like, for capturing image data of the surrounding physical environment. In some embodiments, image capture devices 138 are configured to capture objects in the field of view of user 110. In some embodiments, image capture devices 139 are configured to capture the body 111 of user 110 in the field of view of image capture devices 139 for identification of a motion 199 of user 110 as a sports-based motion 191.

In some embodiments, console 106 may be a single computing device, such as a gaming console, workstation, a desktop computer, or a laptop. In some embodiments, console 106 may be distributed across a plurality of computing devices, such as a distributed computing network, a data center, or a cloud computing system. In some embodiments, console 106, HMD 112, and sensors 90 may be, for example, communicatively coupled via network 104, which may be a wired or wireless network, such as, WiFi, a mesh network or a short-range wireless communication medium. Although HMD 112 is depicted as being in communication with, e.g., tethered to or in wireless communication with, console 106, in some implementations HMD 112 may operate as a stand-alone, mobile artificial reality system.

In some embodiments, artificial reality system 10 uses information captured from a real-world, 3D physical environment to render artificial reality content 122 for display to user 110. In some embodiments, user 110 views the artificial reality content 122 constructed and rendered by an artificial reality application executing on console 106 and/or HMD 112. In some embodiments, artificial reality content 122 may be a consumer gaming application in which user 110 is rendered as avatar with one or more virtual or real objects 128A, 128B. In some embodiments, artificial reality content 122 may comprise a mixture of real-world imagery and virtual objects, e.g., mixed reality and/or augmented reality. In some embodiments, artificial reality content 122 may be, e.g., a video conferencing application, a navigation application, an educational application, training or simulation applications, or other types of applications that implement virtual reality.

In some embodiments, during operation of artificial reality system 10, the artificial reality application constructs artificial reality content 122 for display to user 110 by tracking and computing pose information for a frame of reference, typically a viewing perspective of HMD 112. In some embodiments, using HMD 112 as a frame of reference, and based on a current field of view as determined by a current estimated pose of HMD 112, the artificial reality application renders 3D artificial reality content 122 which, in some examples, may be superimposed, at least in part, upon the real-world, 3D physical environment of user 110.

In some embodiments, while user 110 is viewing the artificial reality content 122 that is displayed in HMD 112, user 110 commences the process of generating sports-based application 181 in HMD 112. In some embodiments, user 110 provides a sports-based initiation indicator 179 as input to the HMD 112 to initiate the sports-based application generation process. In some embodiments, for example, the sports-based initiation indicator 179 may be, for example, a hand gesture, such as a closed fist, tapping of an index finger and thumb, a peace sign, or the like to initiate the sports-based application generation process.

In some embodiments, after user 110 has initiated the sports-based application process using the sports-based initiation indicator 179, image capture devices 139 procure motion data representative of the motion 199 of the body 111 of user 110. HMD 112 receives the motion data and assesses the motion data to determine whether the motion 199 is representative of sports-based motion 191. In some embodiments, in response to identifying the motion 199 of user 110 as a sports-based motion 191, the sports-based application generator generates a sports-based motion application 181 specific to the sports-based motion identified by HMD 112. In some embodiments, for example, the sports-application generator generates the sports-based applications 181, e.g., sports-based sporting news 181A and/or sports-based purchasing options 181B, which are superimposed on underlying artificial reality content 122 being presented to the user 110. In some embodiments, sports-based applications 181 may be viewed as part of or instead of the artificial reality content 122 being presented to the user 110 in the HMD 112 of artificial reality system 10.

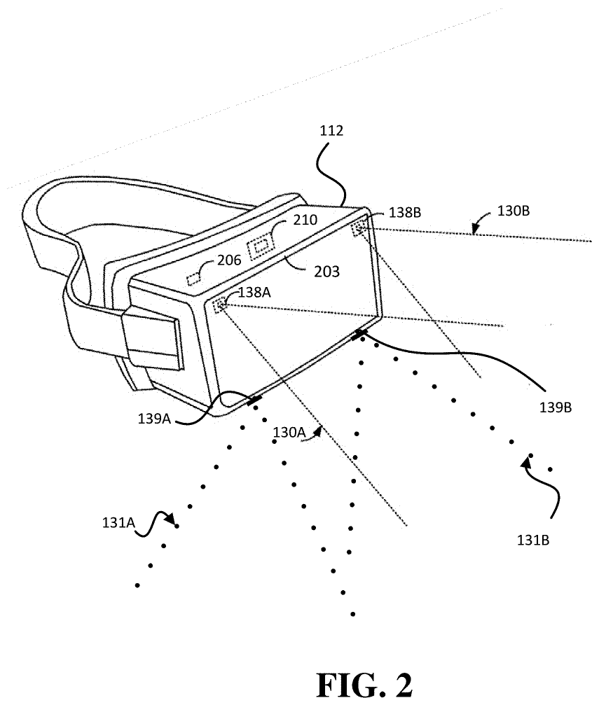

FIG. 2 illustrates an example HMD 112 configured to generate the sports-based applications 181 using the sports-based application generator in accordance with some embodiments. In some embodiments, as stated previously, HMD 112 may be part of artificial reality system 10 of FIG. 1 or may operate as a stand-alone, mobile artificial realty system configured to implement the techniques described herein. In some embodiments, HMD 112 includes a front rigid body and a band to secure HMD 112 to user 110. In some embodiments, the band may include image capture devices 139 that are configured to capture the body 111 of user 110 for generation of the sports-based applications 181 in HMD 112. In addition, HMD 112 includes an interior-facing electronic display 203 configured to present artificial reality content 122 to the user 110. In some embodiments, electronic display 203 may be any suitable display technology, such as liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating visual output. In some examples, the electronic display is a stereoscopic display for providing separate images to each eye of the user 110. In some examples, the known orientation and position of display 203 relative to the front rigid body of HMD 112 is used as a frame of reference, also referred to as a local origin, when tracking the position and orientation of HMD 112 for rendering artificial reality content 122 according to a current viewing perspective of HMD 112 and the user 110. In other examples, HMD 112 may take the form of other wearable head mounted displays, such as glasses.

In some embodiments, HMD 112 further includes one or more motion sensors 206, such as one or more accelerometers (also referred to as inertial measurement units or “IMUs”) that output data indicative of current acceleration of HMD 112, GPS sensors that output data indicative of a location of HMD 112, radar or sonar that output data indicative of distances of HMD 112 from various objects, or other sensors that provide indications of a location or orientation of HMD 112 or other objects within a physical environment. In some embodiments, HMD 112 may include image capture devices 138A and 138B (collectively, “image capture devices 138”) and image capture devices 139A and 139B (collectively, “image capture devices 139”). In some embodiments, as stated previously, image capture devices 138 and image capture devices 139 may be, for example, video cameras, laser scanners, Doppler radar scanners, depth scanners, or the like, configured to output image data representative of the physical environment. In some embodiments, image capture devices 138 capture image data representative of objects in the physical environment that are within a field of view 130A and a field of view 130B of image capture devices 138, which typically corresponds with the viewing perspective of HMD 112. In some embodiments, image capture devices 139 capture motion data of the body 111 of user 110 or image data representative of objects in the physical environment that are within a field of view 131A and a field of view 131B of image capture devices 139. In some embodiments, the field of view 131A and the field of view 131B correspond to a viewing perspective of the body 111 of user 110 from HMD 112.

In some embodiments, HMD 112 includes a control unit 210, which may include a power source and one or more printed-circuit boards having one or more processors, memory, and hardware to provide an operating environment for executing programmable operations to process captured data from image capture devices 138 and image capture devices 139 and present artificial reality content on display 203. In some embodiments, control unit 210 is configured to, based on the motion data received from image capture devices 138 and image capture devices 139 corresponding to the body 111 of user 110, identify a sports-based motion of user 110 and, in response, generate sports-based applications 181. In some embodiments, for example, in response to identifying a sports-based motion, control unit 210 may generate a sports-based news content 181A and/or a sports-based purchasing content 181B (depicted by example in FIG. 1) that is superimposed on artificial reality content for display on electronic display 203. In some embodiments, utilization of image capture devices 139 whose field of view 131 (e.g., field of view 131A and field of view 131B) corresponds to the body of user 110 is an improvement over traditional systems because it allows image capture devices 139 to focus specifically on the body 111 of user 110 to identify the varying sports-based motions of user 110.

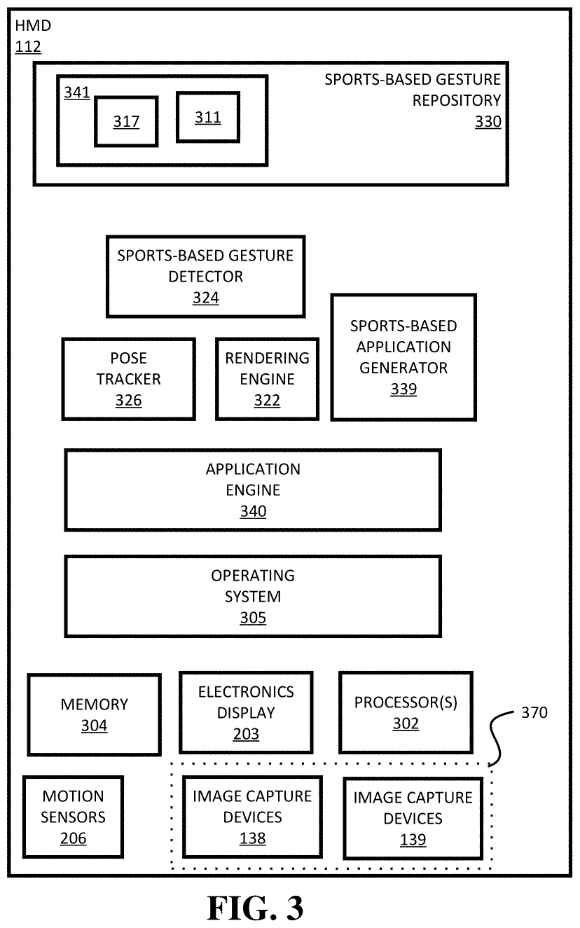

FIG. 3 illustrates a block diagram of HMD 112 of the artificial reality system 10 of FIG. 1 that includes a sports-based application generator 339 that generates sports-based motion applications 181 in accordance with some embodiments. In some embodiments, HMD 112 includes one or more processors 302 and memory 304 that, in some examples, provide a computer platform for executing an operating system 305, which may be an embedded, real-time multitasking operating system, for instance, or other type of operating system. In some embodiments, processor(s) 302 are coupled to electronic display 203, motion sensors 206, image capture devices 138, and image capture devices 139 of FIG. 1 and FIG. 2.

In some embodiments, operating system 305 is configured to provide a multitasking operating environment for executing one or more software components, such as, for example, application engine 340, rendering engine 322, sports-based gesture detector 324, pose tracker 326, and sports-based application generator 339. In some embodiments, the software components are configured to generate the sports-based applications 181 that are superimposed on, or as part of, the artificial reality content for display to user 110 in accordance with the detected sports-based motions of user 110.

In some embodiments, rendering engine 322 is configured to construct the 3D, artificial reality content or artificial reality content which may be superimposed, at least in part, upon the real-world, physical environment of user 110.

In some embodiments, sports-based gesture repository 330 is configured to provide entries that specify defined sports-based motions 311 (which may include a specific gesture or plurality of gestures that represent sports-based motions), sports-based motion indicator/s 317 that are indicative of sports motions carried out by user 110.

In some embodiments, sports-based gesture detector 324 is configured to detect objects recognized within image data and motion data captured by image capture devices 138 and image capture devices 139 of HMD 112 and/or sensors 90 or external cameras 102 to identify a body 111 of user 110. In some embodiments, the image data and motion data are used to track movements of the body 111 relative to HMD 112 to identify sports-based gestures or motions performed by user 110. In some embodiments, sports-based gesture detector 324 compares motion vectors of the objects in the field of view of image capture devices to one or more entries in sports-based gesture repository 330 to identify whether the sports-based motion performed by user 110.

In some embodiments, sports-based application generator 339 includes sports-based motion conditions that are applied against the sports-based motions stored in sports-based gesture repository 330 to trigger the generation of the sports-based applications 181. In some embodiments, sports-based application generator 339 is configured to generate sports-based applications 181 using, for example, the recognition output of sports-based gesture detector 324. In some embodiments, the sports-based applications 181 are superimposed upon, the artificial reality content to be displayed to user 110 on HMD 112.

In some embodiments, in operation, image capture devices 139 capture a motion 199 carried out by a user 110 of the head-mounted display device 301. In some embodiments, the motion 199 may be a sports motion, such as, for example, a dancing motion, a tennis motion, a volleyball motion, a swimming motion, a rock-climbing motion, a skiing motion, a gunning motion, an archery motion, a golfing motion, basketball motion, a football motion, a horse racing motion, a roller-skating motion, a cycling motion, a sailing motion, a swimming motion, a baseball motion, a boxing motion, a cricket motion, a bull-riding motion, a lacrosse motion, or other motion 199 indicative of a sport. In some embodiments, after capturing the motion data corresponding to motion 199, image capture devices 370 provide the motion data to processor 302.

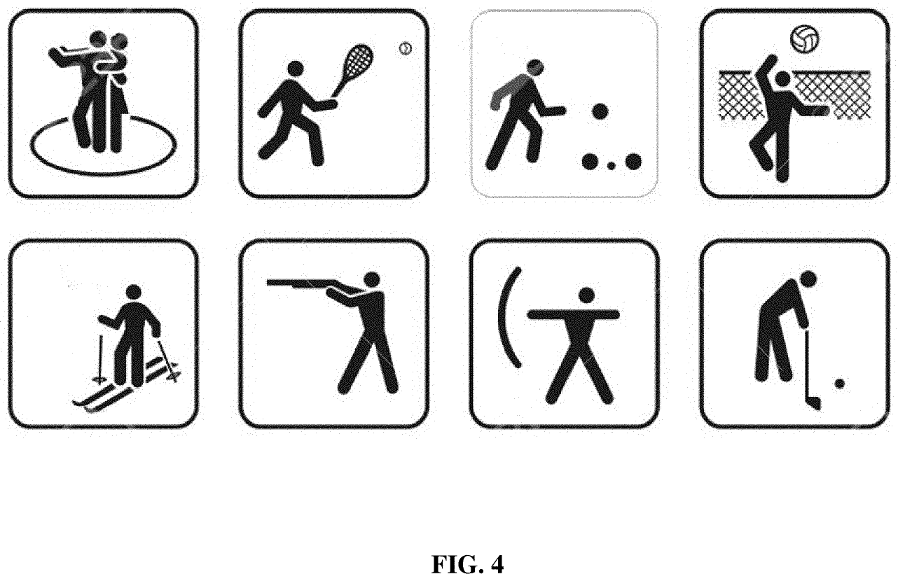

In some embodiments, processor 302 receives motion data representing the motion 199 of user 110 and, utilizing sports-based gesture detector 324 and sports-based gesture repository 330, determines (or identifies) whether the motion 199 performed by user 110 is a sports-based motion 311. In some embodiments, sports-based gesture detector 324 identifies whether the motion 199 carried out by the user 110 is a sports-based motion 311 by using sports-based information 341 stored in sports-based gesture repository 310. In some embodiments, the sports-based information 341 includes sports-based motions 311 and a sports-based motion indicator 317. In some embodiments, the sports-based motion indicator 317 is an indicator that is indicative of a sports motion carried out by user 110. For example, in some embodiments, the sports-based motion indicator 317 may be sports-based motion data that corresponds to a video clip of user 110 performing the sports-based motion 311. In some embodiments, the video clip may be, for example, user 110 performing the dancing motion, the tennis motion, the volleyball motion, etc. depicted by example in FIG. 4. In some embodiments, sports-based gesture detector 324 utilizes sports-based information 341 stored in sports-based gesture repository 330 or classifying algorithms or machine learning techniques executed thereon, to identify a motion 199 as a sports-based motion 311. In some embodiments, the motion 199 is identified as a sports-based motion 311 based on predefined sports-based motions stored in sports-based gesture repository 330.

In some embodiments, after determining whether the motion 199 is a sports-based motion 311, sports-based application generator 339 generates a sports-based motion application 391 specific to the motion 199 in the HMD 112 based upon the identification of the motion as the sports-based motion 311. In some embodiments, in order to generate the sports-based application on the display of HMD 112, sports-based application generator 339 scours network 104 for sports-based content related to the identified sports-based motion. In some embodiments, the sports-based motion application 391 is content related to the sport-based motion 311, such as, for example, a sports-based internet application, a sports-based video application, or a sports-based news application. For example, if the sports-based motion 311 performed by the user 110 is a boxing motion, then processor 302 may display news clips on the display of HMD 112 that correspond to the sport of boxing. In some embodiments, once sports-based application generator 339 has found content related to the sports-based motion, sports application generator 339 superimposes the sports-based content onto the artificial reality content rendered by rendering engine 322 on the electronics display 203 of HMD 112.

In some embodiments, after the sports-based applications 181 are displayed as part of the artificial reality content provided to user 110, user 110 is then able to view and navigate the sports-based content provided on the electronics display 203 of HMD 112. Thus, user 110 is able to easily view sports-based content in HMD 112 specified by a sports-based motion 311 while simultaneously viewing artificial reality content.

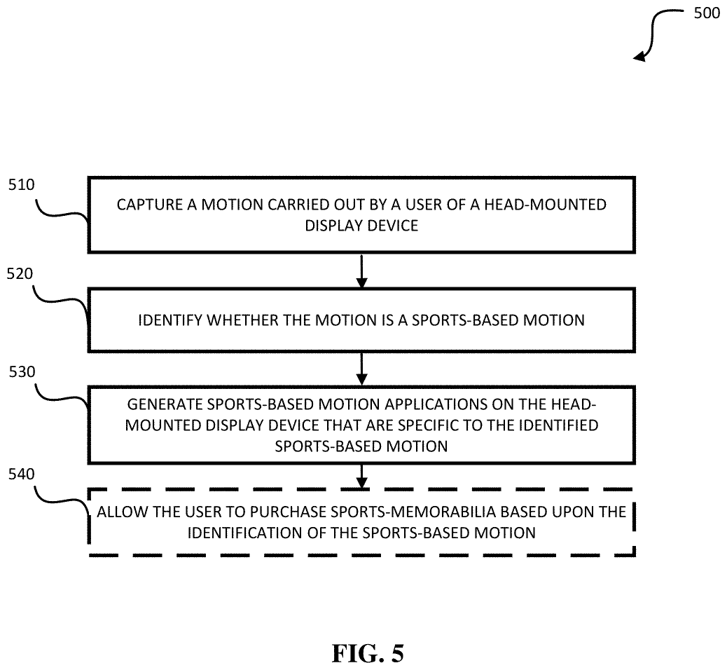

FIG. 5 illustrates a method 500 of generating sports-based content on the HMD of FIG. 1 in accordance with some embodiments. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments.

In some embodiments, with reference to FIG. 1-FIG. 4, at block 510, image capture device 139 of HMD 112 captures a motion 199 carried out by the user 110 of HMD 112. In some embodiments, at block 520, processor 302 uses sports-based gesture detector 324 and sports-based gesture repository 330 to identify whether the motion 199 is a sports-based motion 311. In some embodiments, at block 530, based on the identification of the motion 199 as a sports-based motion 311, sports-based application generator 339 generates a sports-based motion application 181 on the HMD 112 that is specific to the sports-based motion 311. For example, in some embodiments, when the sports-based motion 311 detected by the sports-based gesture detector 324 is a boxing motion, sports-based application generator 339 generates sports-based applications 181B superimposed over the virtuality reality or augment reality content, such as, for example, recent news or video games that are relevant to boxing, such as, recent amateur or professional boxing matches. In some embodiments, optionally, at block 540, based on the identification of the motion 199 as a sports-based motion 311, sports-based application generator 339 generates sports-based purchasing options 181B that allow user 110 to purchase sports merchandise, sports memorabilia, or the like based on the identification of the sports-based motion 311. In some embodiments, optionally, at block 540, sports-based application generator 339 generates purchasing options that allow user 110 to purchase sports merchandise, sports memorabilia, or the like based on the identification of a sports identifier 198 on the body 111 of user 110, such as, for example, a sports team logo on a shirt that the user 110 is wearing. In some embodiments, for example, when user 110 is wearing a t-shirt that has a sports identifier 198 that states “La Union Lions” (as depicted in FIG. 1), sports-based application generator 339 superimposes options to purchase similar sports memorabilia on the artificial reality content or augmented reality content provided on the electronics display 303 of HMD 112.

In some embodiments, a method includes capturing a motion carried out by a user of a head-mounted display device; identifying whether the motion is a sports-based motion; and generating sports-based motion applications specific to the motion in the head-mounted display device based upon the identification of the motion as the sports-based motion. In some embodiments of the method, a computer processor identifies whether the motion carried out by the user of the head-mounted display device is the sports-based motion. In some embodiments of the method, the computer processor uses prior information related to a sports-based motion indicator provided by the user carrying out the motion to identify the motion as the sports-based motion. In some embodiments of the method, the sports-based motion is at least one of a dancing motion, a tennis motion, a volleyball motion, a swimming motion, a rock-climbing motion, a skiing motion, a gunning motion, an archery motion, a golfing motion, basketball motion, a football motion, a horse racing motion, a roller-skating motion, a cycling motion, a sailing motion, a swimming motion, a baseball motion, a boxing motion, a cricket motion, a bull-riding motion, and a lacrosse motion. In some embodiments of the method, the sports-based motion applications include sports-based content related to the sports-based motion of the user. In some embodiments of the method, the sports-based content includes at least one of a sports-based internet application, a sports-based video application, or a sports-based news application. In some embodiments of the method, the computer processor utilizes a machine learning technique to determine whether the motion is the sports-based motion. In some embodiments, based on the identification of the motion performed by the user of the HMD as a sports-based motion, the user may be virtually transported instantaneously or near-instantaneously to a sport specific to the sports-based motion performed by the user.

In some embodiments, a system includes a display; and a computer processor configured to capture a motion carried out by a user of the display; identify the motion as a sports-based motion; and generate sports-based applications specific to the motion on the display based upon the identification of the motion as the sports-based motion. In some embodiments of the system, prior to identifying the motion, the user is prompted to input a sports-based motion indicator that is indicative of the sports-based motion to be carried out by the user. In some embodiments of the system, the computer processor identifies the motion as the sports-based motion based on the sports-based motion indicator input by the user. In some embodiments of the system, the sports-based motion indicator is video of the user carrying out the sports-based motion. In some embodiments of the system, the computer processor identifies the motion as the sports-based motion by using motion information provided by a wearable device that is worn by the user.

In some embodiments of the system, the wearable device includes sensors that allow the computer processor to identify the motion as the sports-based motion. In some embodiments of the system, the computer processor identifies whether the user is wearing sports-based memorabilia representative of a sports team related to the sports-based motion. In some embodiments of the system, the computer processor is configured to generate sports-based content related to the sports team based on the identification of the sports team by the computer processor. In some embodiments of the system, the computer processor is configured to generate purchasing options on the display that allow the user to purchase sports memorabilia related to the sports team identified by the computer processor. In some embodiments of the system, a machine learning technique identifies the motion of the user as the sports-based motion based upon prior sports-based motions of the user and prior sports-based motions of others.

In some embodiments, a head-mounted display device includes a motion capturing device; a display communicatively coupled to the motion capturing device, wherein based upon the motion capturing device capturing a sports-based motion carried out by a user, a computer processor generates sports-based applications on the display that are specific to the sports-based motion identified using the motion capturing device. In some embodiments of the head-mounted display device, the computer processor identifies the sports-based motion by comparing the sports-based motion to a repository of sports-based motions of the user of the head-mounted display device. In some embodiments of the head-mounted display device, the motion capturing device includes a camera located on a band of the head-mounted display device.

1. A method, comprising:
capturing a motion carried out by a user of a head-mounted display device;
identifying whether the motion is a sports-based motion; and
generating sports-based motion applications specific to the motion in the head-mounted display device based upon the identification of the motion as the sports-based motion, wherein the user is virtually transported to a sport specific to the sports-based motion performed by the user.

2. The method of claim 1, wherein:
a computer processor identifies whether the motion carried out by the user of the head-mounted display device is the sports-based motion.

3. The method of claim 2, wherein:
the computer processor uses prior information related to a sports-based motion indicator provided by the user carrying out the motion to identify the motion as the sports-based motion.

4. The method of claim 3, wherein:
the sports-based motion is at least one of a dancing motion, a tennis motion, a volleyball motion, a swimming motion, a rock-climbing motion, a skiing motion, a gunning motion, an archery motion, a golfing motion, basketball motion, a football motion, a horse racing motion, a roller-skating motion, a cycling motion, a sailing motion, a swimming motion, a baseball motion, a boxing motion, a cricket motion, a bull-riding motion, and a lacrosse motion.

5. The method of claim 4, wherein:
the sports-based motion applications include sports-based content related to the sports-based motion of the user.

6. The method of claim 5, wherein:
the sports-based content includes at least one of a sports-based internet application, a sports-based video application, or a sports-based news application.

7. The method of claim 2, wherein:
the computer processor utilizes a machine learning technique to determine whether the motion is the sports-based motion.

8. A system, comprising:
a display; and
a computer processor configured to:
capture a motion carried out by a user of the display;
identify the motion as a sports-based motion; and
generate sports-based applications specific to the motion on the display based upon the identification of the motion as the sports-based motion, wherein the user is virtually transported to a sport specific to the sports-based motion performed by the user.

9. The system of claim 8, wherein:
prior to identifying the motion, the user is prompted to input a sports-based motion indicator that is indicative of the sports-based motion to be carried out by the user.

10. The system of claim 9, wherein:
the computer processor identifies the motion as the sports-based motion based on the sports-based motion indicator input by the user.

11. The system of claim 10, wherein:
the sports-based motion indicator is video of the user carrying out the sports-based motion.

12. The system of claim 8, wherein:
the computer processor identifies the motion as the sports-based motion by using motion information provided by a wearable device that is worn by the user.

13. The system of claim 12, wherein:
the wearable device includes sensors that allow the computer processor to identify the motion as the sports-based motion.

14. The system of claim 10, wherein:
the computer processor identifies whether the user is wearing sports-based memorabilia representative of a sports team related to the sports-based motion.

15. The system of claim 14, wherein:
the computer processor is configured to generate sports-based content related to the sports team based on the identification of the sports team by the computer processor.

16. The system of claim 15, wherein:
the computer processor is configured to generate purchasing options on the display that allow the user to purchase sports memorabilia related to the sports team identified by the computer processor.

17. The system of claim 13, wherein:
a machine learning technique identifies the motion of the user as the sports-based motion based upon prior sports-based motions of the user and prior sports-based motions of others.

18. A head-mounted display device, comprising:
a motion capturing device;
a display communicatively coupled to the motion capturing device, wherein based upon the motion capturing device capturing a sports-based motion carried out by a user, a computer processor generates sports-based applications on the display that are specific to the sports-based motion identified using the motion capturing device, wherein the user is virtually transported to a sport specific to the sports-based motion performed by the user.

19. The head-mounted display device of claim 18, wherein:
the computer processor identifies the sports-based motion by comparing the sports-based motion to a repository of sports-based motions of the user of the head-mounted display device.

20. The head-mounted display device of claim 19, wherein:
the motion capturing device includes a camera located on a band of the head-mounted display device.
